(19) United States
(12) Patent Application Publication
(10) Pub. No.: US 2010/0082271 A1
(43) Pub. Date: Apr. 1, 2010

(54) FLUID LEVEL AND CONCENTRATION SENSOR

(76) Inventors: James D. McCann, Waynesville, OH (US); Dan C. Lyman, Cincinnati, OH (US); George Andrew Reich, Corydon, IN (US)

Correspondence Address: Andrew J. Anderson;Patent Legal Staff, Eastman Kodak Company, 343 State Street, Rochester, NY, 14650-2201, US

(21) Appl. No.: 12/241,132

(22) Filed: Sep. 30, 2008

(51) Int. Cl. G01F 23/24; G01F 23/00

(52) U.S. Cl. 702/55; 73/304 R; 73/295

(57) ABSTRACT

A sensor includes a first set of electrodes, a second set of electrodes, and at least one electrical circuit. The first set of electrodes is completely submergible in a fluid. The second set of electrodes is partially submergible in the fluid. The at least one electrical circuit is configured to measure resistance of the fluid between the first set of electrodes and configured to measure resistance of the fluid between the second set of electrodes.

### FIELD OF THE INVENTION

This invention relates generally to fluid level and fluid concentration sensors, and in particular to fluid level and fluid concentration sensors suitable for use in inkjet printing systems.

### BACKGROUND OF THE INVENTION

Monitoring levels and concentrations of a fluid in a in fluid reservoir are known.

In inkjet printing applications, continuous monitoring and controlling of fluid (for example, ink) characteristics helps to maintain print quality. For example, in continuous inkjet printing (commonly referred to as CIJ) systems, monitoring and controlling the concentration of the dye component of the ink helps to maintain the consistency of ink color, to maintain the consistency of drop formation, and to maintain drop control, for example, drop deflection, during printing. However, ink levels in the ink reservoir are continuously being depleted during printing. Additionally, the aqueous component of the ink is constantly being depleted, particularly during printing, which can lead to an increase the concentration of the dye component of the ink. If ink fluid characteristics are not monitored and controlled, reduced print quality can result.

The sensors that are used to monitor and control fluid characteristics in inkjet printing systems should be robust enough to withstand the printing environment. For example, in CIJ applications, the sensors should be minimally or even unaffected by fluid foam; appropriately sized for the ink reservoir; and insensitive to fluid flow and/or reservoir size. The sensors should also have sufficient depth resolution to monitor and control ink characteristics regardless of the color of the ink.

Accordingly, there is an ongoing need to improve the accuracy and reliability of fluid level and concentration sensors suitable for use in inkjet printing systems.

### SUMMARY OF THE INVENTION

An objective of the present invention is to provide a passive sensor device that accurately determines solute concentration and fluid levels in a variety of fluids.

According to one feature of the present invention, a sensor includes a first set of electrodes, a second set of electrodes, and at least one electrical circuit. The first set of electrodes is completely submergible in a fluid. The second set of electrodes is partially submergible in the fluid. The at least one electrical circuit is configured to measure resistance of the fluid between the first set of electrodes and configured to measure resistance of the fluid between the second set of electrodes.

According to another feature of the present invention, a processor is provided in electrical communication with the electric circuit and is configured to receive the resistance information from the electrical circuit and calculate a fluid level of the fluid.

According to another feature of the present invention, a temperature sensing device is provided and configured to sense the temperature of the fluid. A processor is provided in electrical communication with the temperature sensing device and the electrical circuit and is configured to receive information from the electrical circuit and the temperature sensing device and calculate a concentration of solute in the fluid.

According to another feature of the present invention, a method of sensing fluid in a fluid reservoir includes providing a first set of electrodes completely submergible in a fluid; providing a second set of electrodes partially submergible in the fluid; providing at least one electrical circuit operable to measure resistance of the fluid between the first set of electrodes and operable to measure resistance of the fluid between the second set of electrodes; measuring the resistance of the fluid between the first set of electrodes; and measuring the resistance of the fluid between the second set of electrodes.

### BRIEF DESCRIPTION OF THE DRAWINGS

In the detailed description of the example embodiments of the invention presented below, reference is made to the accompanying drawings, in which:

FIG. 1 is a schematic representation of a continuous inkjet printing system including an example embodiment of the present invention;

FIG. 2 is a schematic representation of an example embodiment of the present invention;

FIG. 3A is a schematic representation of an example embodiment of the present invention including electrical and sense circuits and sense electrodes that are partially submergible in the fluid;

FIG. 3B is a schematic representation of an example embodiment of the present invention including electrical and sense circuits and sense electrodes that are fully submergible in the fluid;

FIG. 4 is a schematic representation of an example embodiment of the present invention including a four electrode arrangement;

FIG. 5 is a schematic representation of an example embodiment of the present invention including a six electrode arrangement;

FIG. 6 is a schematic representation illustrating connection of like-terminal electrodes in a six electrode arrangement;

FIG. 7 is a perspective view of an example embodiment of a first probe including completely submergible electrodes;

FIG. 8 is a perspective view of an example embodiment of a second probe including partially submergible electrodes;

FIG. 9 is an exploded view of FIG. 8;

FIG. 10 is a logic diagram for a method of sensing fluid in a fluid reservoir according to the present invention; and

FIGS. 11 and 12 are schematic illustrations of additional example embodiments of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

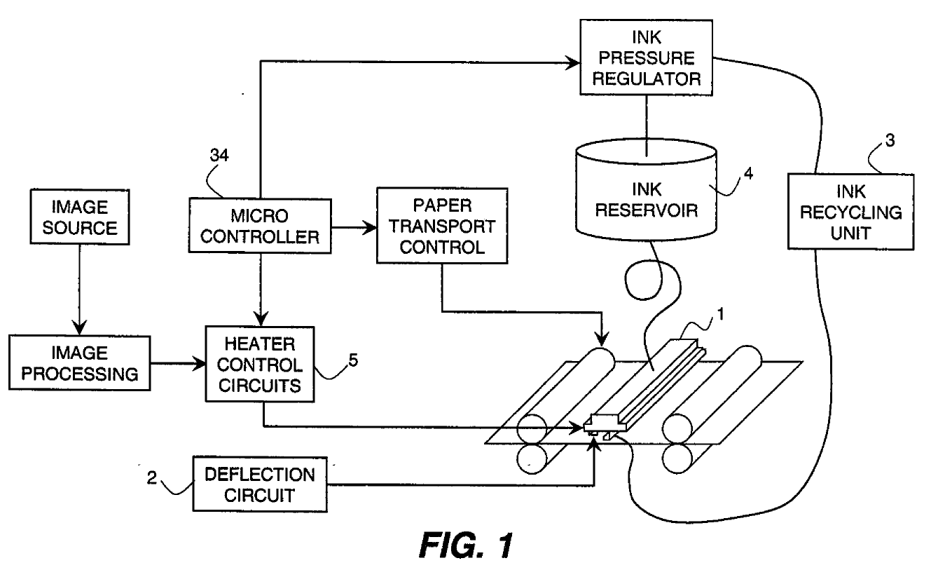

Referring to FIG. 1, CIJ systems include a drop generator 1 that creates a continuous stream of fluid from a nozzle, which upon receiving the appropriate stimulation, the stream breaks up in a predictable manner into droplets. Using one of various conventional methods, some of the droplets are printed onto a substrate while other droplets are deflected into a catcher when print is not desired. In FIG. 1, asymmetric heat stimulation 5 and deflection circuitry 2 are shown. Those droplets deflected into the catcher are directed to the ink recycling unit 3 and replaced into a fluid reservoir 4, which supplies ink to the drop generator 1.

Through normal operation, fluid loss is possible. For example, fluid is lost through the printing of droplets and general evaporation of the aqueous components of the ink. This can lead to an increase in the concentration of the dye component within the ink which can then lead to inconsistent print color. Therefore, CIJ systems are equipped with an ink supply and a replenisher which is essentially ink without dye.

The concentrations of a solute within a fluid created for a specific function are quite often extremely vital to the functionality of that fluid. This is particularly true with respect to dye solutions for use in continuous inkjet (CIJ) printing systems. Not only is it critical to maintain the fluidity and viscosity of the fluid so that the fluid is jettable, but the concentration of the dye is also critical in the consistent reproducibility of the printed color of the ink.

It is imperative to obtain precise dye concentration measurements throughout the course of the CIJ system operation. The ink fluid resistivity is a function of both the dye concentration and the temperature of the ink. Generally, fluid levels can be read by an exposed set of level sensor electrodes and the electrical resistance between electrodes is measured. That is, as the wires are submerged further into the fluid, the resistance between them decreases. Thus, the change in resistance is inversely proportional to the submerged height. Conductance (the inverse of resistance) therefore, is linearly dependant on the height of the fluid on the electrodes.

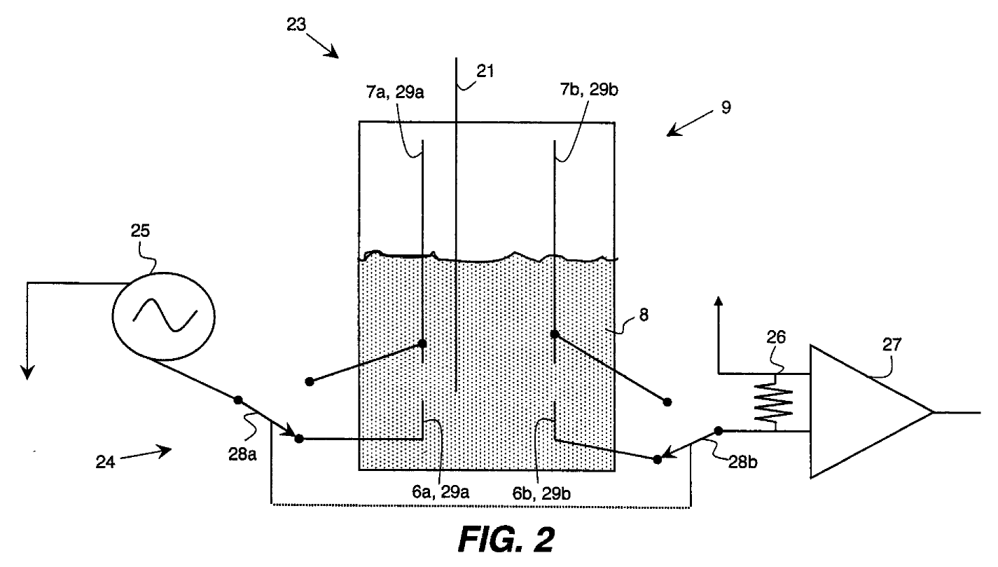

A temperature sensing device 21, shown in FIG. 2, can be used to determine the actual ink fluid temperature while a set of submerged electrodes determines resistivity. A calculation then corrects the resistivity to a standard value at 25° C. A CIJ system uses this information to determine whether to add ink or replenisher (which does not contain dye) when the ink tank is low on fluid. In turn, the dye is maintained at the proper concentration.

However, the assumption that the electrical field strength is uniform along a path from one electrode to the other is incorrect. The electric field is only constrained by the following conditions: (1) it must obey Gauss's Law; (2) at a non-conductive surface, the normal component of the electrical field must be zero (in the quasi-static analysis), otherwise charge would continue to build up on the surface without fettering; and (3) any component of the electrical field that is tangential to the conductive electrodes must be zero. As a result, though the conductance is still directly proportional to the height, the constant of proportionality can only be obtained using a more sophisticated model, which must include the geometry of the sensor. As such, the determination of the fluid level within a fluid reservoir should include the conductance between the electrodes of the probes comprising the sensor, the resistivity of the fluid, and the geometry of the sensor. If all other components are constant, fluid height on the electrode is linearly dependent on the conductance between the probes.

Referring to FIG. 2, a sensor 23 which includes a first set of electrodes 6, a second set of electrodes 7, and at least one electrical circuit 24 is shown. First set of electrodes 6 includes electrodes 6a and 6b, and is completely submergible in the fluid 8 contained in fluid reservoir 9. Second set of electrodes 7 includes electrodes 7a and 7b, and is partially submergible in the fluid 8 within the fluid reservoir 9. Electrical circuit 24 is configured and operable to measure the resistance of the fluid between the first set of electrodes 6 and to measure the resistance of the fluid between the second set of electrodes 7. Alternatively, separate electrical circuits can be associated with each set of electrodes 6 and 7, although energizing multiple circuits at the same time can result in interference unless the circuits are sufficiently removed from one another within the fluid reservoir 9.

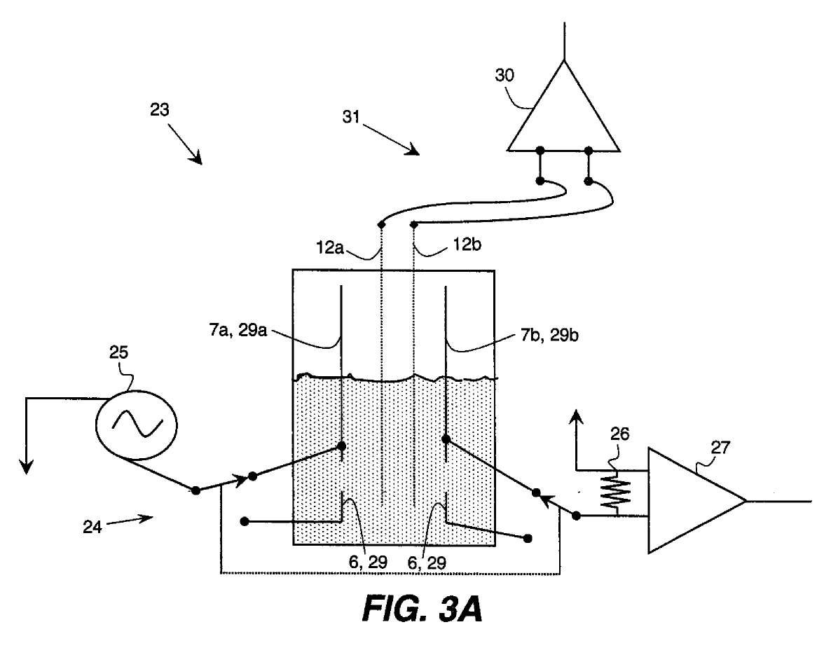

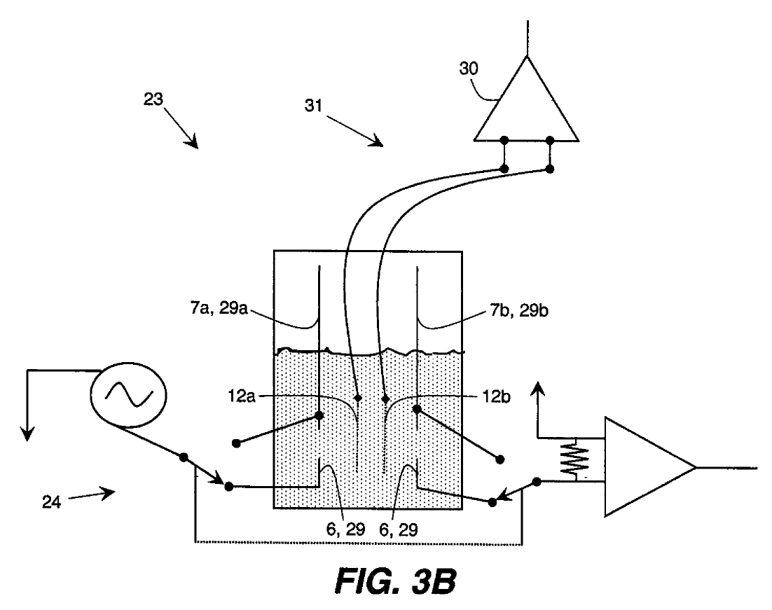

The electrical circuit 24 of sensor 23 includes a voltage source 25, a resistor 26, a driven amplifier 27, and at least one set of electrodes 29. Set of electrodes 29 can be either first set of electrodes 6 or second set of electrodes 7 and is used herein to describe the sets of electrodes generally. Voltage source 25 can provide alternating current (AC), as shown in FIG. 2, or direct current (DC) to the circuit 24, although AC is preferable because of the electroplating on the electrodes that can result from the use of DC. The voltage travels through electrical wires, through the fluid 8 between the set of electrodes 29, and through the resistor 26. Resistor 26 is preferably of low resistance so as to maintain the voltage drop across the fluid 8. Driven amplifier 27 is preferably of high impedance, such that very little current passes through it. Driven amplifier 27 senses the current (I_{fluid}) through the circuit, amplifies the signal, and feeds the signal to a processor (for example, microcontroller 34 shown in FIG. 1). Switches 28a and 28b are both activated to select either the first set of electrodes 6, such as is shown in FIG. 2, or the second set of electrodes 7, such as is shown in FIG. 3A, for inclusion in the electrical circuit 24 when one electrical circuit 24 is used in conjunction with multiple sets of electrodes.

In other example embodiments of the present invention, described in more detail below, walls 38 are included to define a resistive path through the fluid 8. Alternatively, the resistive path can be defined by the sides of the fluid reservoir 9 or foam barrier 17.

Readings obtained from the electrodes are dependent upon fluid characteristics and the electrode material (such as electrode resistance, contact resistance, contact capacitance, passivation, and fluid polarization). These characteristics of the fluid and electrodes are difficult to maintain and can cause the voltage supplied to the fluid to be less than the actual drive voltage. Thus, in the example embodiment shown in FIG. 3A, a second circuit, a sense circuit 31, is also provided. A third set of electrodes, a set of sense electrodes 12, can be partially submergible in the fluid 8, as shown in FIG. 3A, or completely submergible in the fluid 8, as shown in FIG. 3B. Third set of electrodes 12 sense, or detect, the electric potential between the sense electrodes 12a and 12b. This electric potential is the result of the current through the fluid produced by the drive electrodes of either first set of electrodes 6 or second set of electrodes 7. The set of sense electrodes 12 pass the signal to sense amplifier 30. Preferably, the set of sense electrodes 12 and sense amplifier 30 are very high impedance such that very little current passes through them, minimizing or even eliminating the effect on the driven current. The voltage sensed between the set of sense electrodes 12 (Vₛₑₙₛₑ) is directly proportional to the voltage across the fluid (V_{fluid}). The constant of proportionality is related to the geometry of the electrodes. As such, obtaining V_{fluid} by dividing Vₛₑₙₛₑ by the known constant of proportionality negates any adverse effects due, for example, to the oxidization of the electrodes that can result in a decreased voltage reading if read directly from the first and second sets of electrodes 6 and 7. The measured voltage signal (V_{fluid}) is fed to the processor 34 (shown in FIG. 1). The processor 34 uses this voltage and current signal (I_{fluid}) to determine the resistance through the fluid (R_{fluid}).

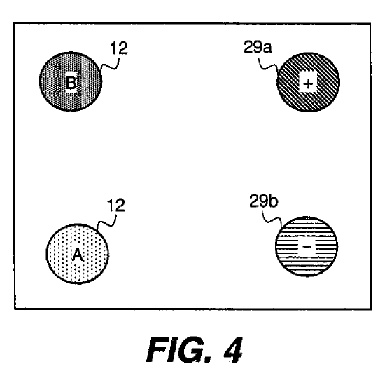

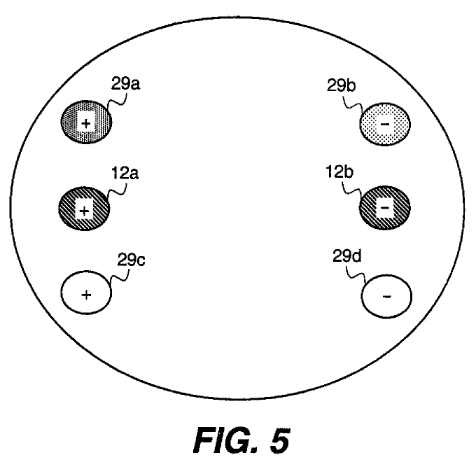

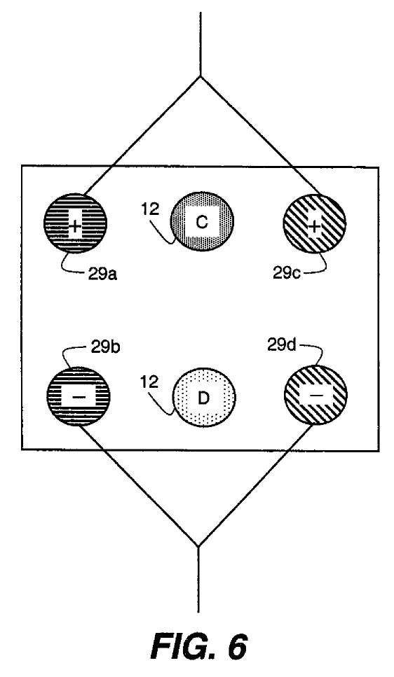

Multiple electrodes can be grouped into probes for ease of handling and to maintain a fixed geometry between the electrodes. This multiple-electrode technique helps to reduce or even eliminate the effect of characteristics of the fluid and the electrodes. Variations in the electrode arrangement depend on the application contemplated. For example, FIG. 4 shows a four-electrode configuration which includes an electrode set 29, which includes electrodes 29a and 29b, and a set of sense electrodes 12a and 12. In the four-electrode arrangement, the voltage is highly dependent upon the placement of sense electrodes 12a and 12b. As such, this configuration is useful in applications where the resolution of detectible concentration differences can be less precise.

Where enhanced sensitivity and resolution of the system are desired, a six-electrode configuration, shown in FIGS. 5 and 6, can be used. FIG. 5 shows an embodiment of a six-electrode configuration in which the electrodes are flush with the face of the probe. In embodiments including a six-electrode configuration, set of electrodes 29 includes four electrodes 29a, 29b, 29c, and 29d. Sense electrode set 12 separates one pair of electrodes, 29a and 29c, from the other pair of electrodes, 29b and 29d, such that like-polarity electrodes are on the same side. As shown in FIG. 6, the like-polarity electrodes 29a and 29c are tied together, as are like-polarity electrodes 29b and 29d. As such, the voltage potential difference between the sense electrodes 12a and 12b is greater than in a four-electrode configuration, which allows for increased sensitivity detection between the electrodes in addition decreased spatial sensitivity. Additionally, this configuration provides for greater leniency in the exact placement of the sense electrodes, increasing reproducibility and decreasing manufacturing costs.

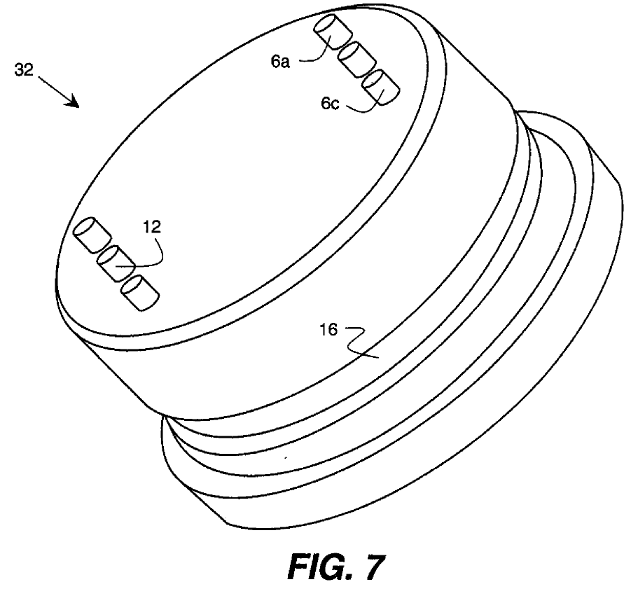

Referring to FIG. 7, an example embodiment of a first probe 32 which is completely submergible in a fluid is shown. First probe 32 includes a six-electrode configuration wherein first set of electrodes 6 includes four electrodes 6a, 6b, 6c, and 6d, separated by a set of sense electrodes 12a and 12b , as described above. As shown, first probe 32 is constructed as a plug such that it can be inserted into a hole in the bottom of the fluid reservoir, allowing for complete submersion of the sets of electrodes 6 and 12. As such, it can include a sealing member 16, for example, an o-ring, to ensure fluid leakage prevention and the ability to remove the probe for repairs and/or replacement. Alternatively, first probe 32 can be attached to the bottom of second probe 33. The construction of the first probe 32 is preferably of plastic, for example polyvinyl chloride (PVC), while the electrodes are preferably constructed of metal, for example stainless steel. PVC is preferred because it is readily available and easily fabricated, but other plastics can be used provided they are compatible with the ink and are good insulators. However, other materials can be used for the probe and/or the electrode sets depending on the application contemplated.

The exposure of the electrodes to the fluid is critical in the first probe 32. The surface area of the electrode exposed to the fluid should be equal for all electrodes and is measured with respect to the surface of the PVC probe for convenience. Preferably, the electrodes are flush with the surface of the PVC comprising the probe or slightly recessed, as shown in FIG. 5. These geometries are preferred due to the reduced error in measurement and equivalent surface area exposed in each arrangement. However, it is possible to have the electrodes protruding slightly from the surface of the PVC probe when precise measurement can be ensured, as is shown in FIG. 7. It should also be noted that regardless of the degree of protrusion of the electrode chosen for a particular application, a tight seal for each electrode is essential to ensure the proper geometry and known surface area exposed to the fluid.

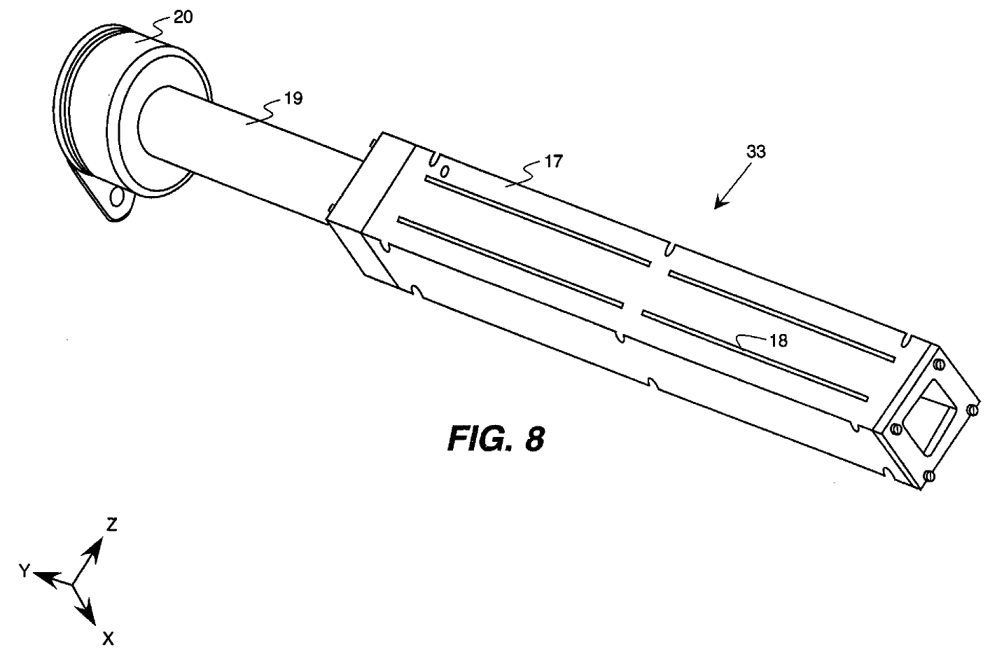

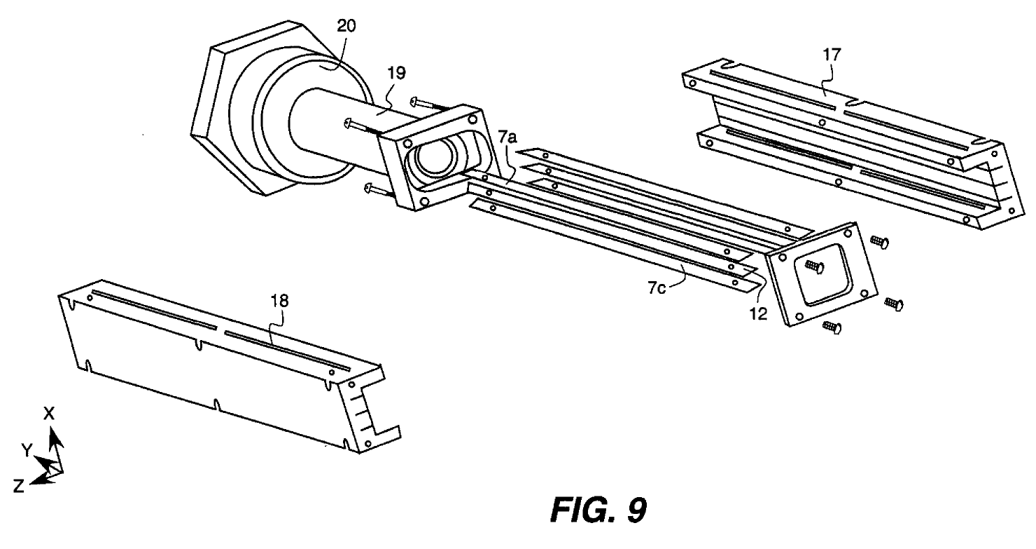

Referring to FIGS. 8 and 9, an example embodiment of a second probe 33 which is partially submergible in the fluid is shown. FIG. 9 is an exploded view of the probe illustrated in FIG. 8 according to one embodiment of the invention. As shown in FIG. 9, the second probe 33 also includes a six-electrode configuration in which second set of electrodes 7 includes four electrodes 7a, 7b , 7c , and 7d , separated by a set of sense electrodes 12a and 12b. In contrast to the first probe 32, the electrodes of second probe 33 have considerable length exposed to fluid, which is necessary for the fluid level measurements.

One issue of particular concern for the second probe 33 with exposed electrodes in the fluid reservoir 9 is the presence of foam in the fluid reservoir. The conductivity of the foam may cause an error in the fluid level measurement. Thus, a foam barrier 17, preferably constructed from plastic, for example, PVC, surrounds the electrodes of probe 33. The foam barrier 17 aids in preventing foam, caused by returning fluid entering from the outer edges of the fluid reservoir 9, from touching the second probe 33. Small openings 18 can be formed in the foam barrier 17 to allow proper mixing of the fluid 8 within the fluid reservoir 9. The small openings preferably extend along the length of the electrodes and are approximately 0.040 inches in width, and typically do not exceed 0.055 inches in order to prevent foam from entering the probe 33. When probe 33 is mounted in the fluid reservoir, openings 18 are typically vertical. Electrical wires (not shown) connected to the sets of electrodes 7 and 12 pass through the bracket 19 to be protected from the fluid within the fluid reservoir. Finally, a mount 20 allows this second probe 33 to be removable from and sealable with the fluid reservoir 9.

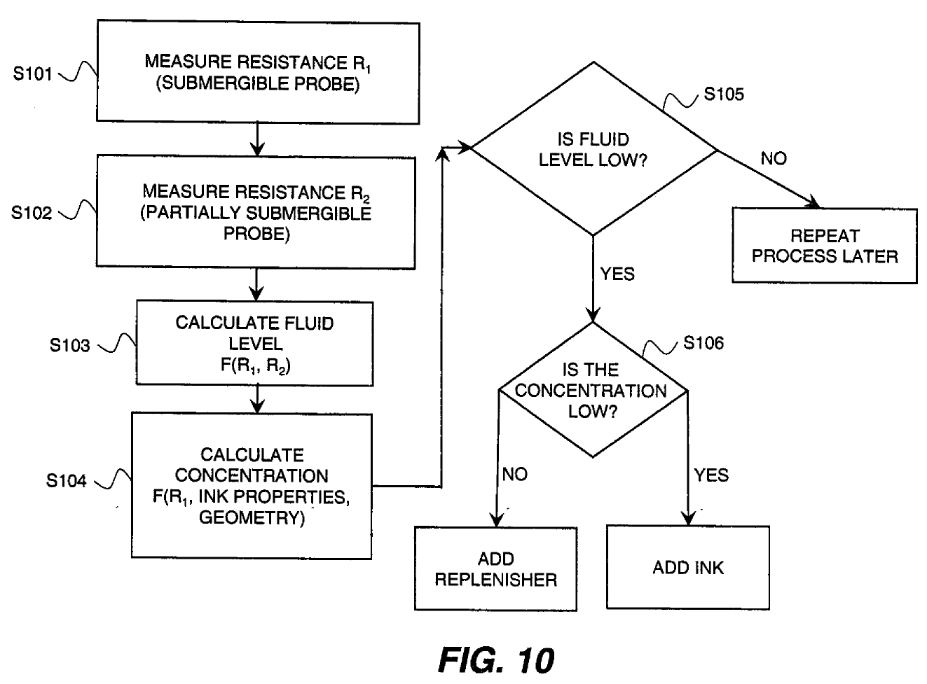

As described above, the present invention provides an accurate measurement of fluid level and solute concentration over a range of fluid types. Referring now to FIG. 10, a method of sensing fluid in a fluid reservoir is shown. Current is applied to first set of electrodes 6 on the first probe 32 using a waveform, preferably a sine waveform, although other waveforms may be used depending on the application contemplated. In step S101, the set of sense electrodes 12 is used to measure voltage through the fluid from first set of electrodes 6. The resultant fluid resistance between the first set of electrodes 6 (the sense electrode detected voltage divided by the drive electrode current and multiplied by a scaling factor that is a function of the geometry) is calculated and later used for normalization. The same drive and sense electrode process is repeated to calculate the resistance across the second set of electrodes 7 of the second probe 33 in step S102.

In step S103, comparison of the resistance calculated from the first and the second sets of electrodes 6 and 7, housed in probes 32 and 33 respectively, is accomplished using an appropriately configured processor 34 and is used to determine the level of fluid 8 in fluid reservoir 9. While the resistance calculated from the second probe 33 is fluid level dependent, the resistance calculated from the first probe 32 is not. Thus, by normalizing the resistance obtained by second probe 33 using the resistance obtained by first probe 32, a fast and accurate determination of whether adequate levels of fluid are within the fluid reservoir 9 can be made. This determination of whether adequate levels of fluid are within the fluid reservoir 9 is decision S105.

Temperature sensing device 21 included in the sensor 23 is used to determine temperature of the fluid. The resistance measurement obtained from the first probe 32, a known geometry factor, and the temperature detected by the temperature sensing device 21 are used to extrapolate the current fluid concentration-dependent conductance from the conductance at the standard temperature value of 25° C., as in step S104. This calculated concentration can then be displayed on a user interface, stored, or otherwise appropriately used.

If the fluid level is determined to be adequate in decision S105, then the decision S106, described below, is not completed and the method is repeated at a later designated time. However, if the fluid level within the fluid reservoir 9 is low, as determined in decision S105, then additional steps can be taken to not only add sufficient volume of fluid 8, but to control the final concentration of fluid 8 within the fluid reservoir 9. If the concentration of solute in the fluid 8 is determined to be high in decision S106, then fluid without solute (replenishment fluid) is added. If the concentration of solute in the fluid 8 is determined to be low, then fluid with solute is added.

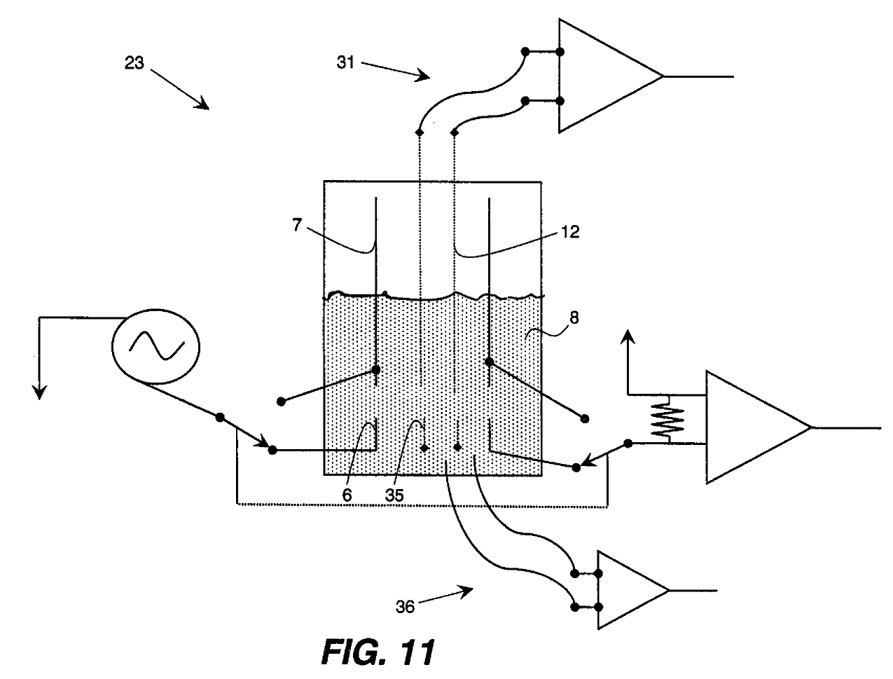

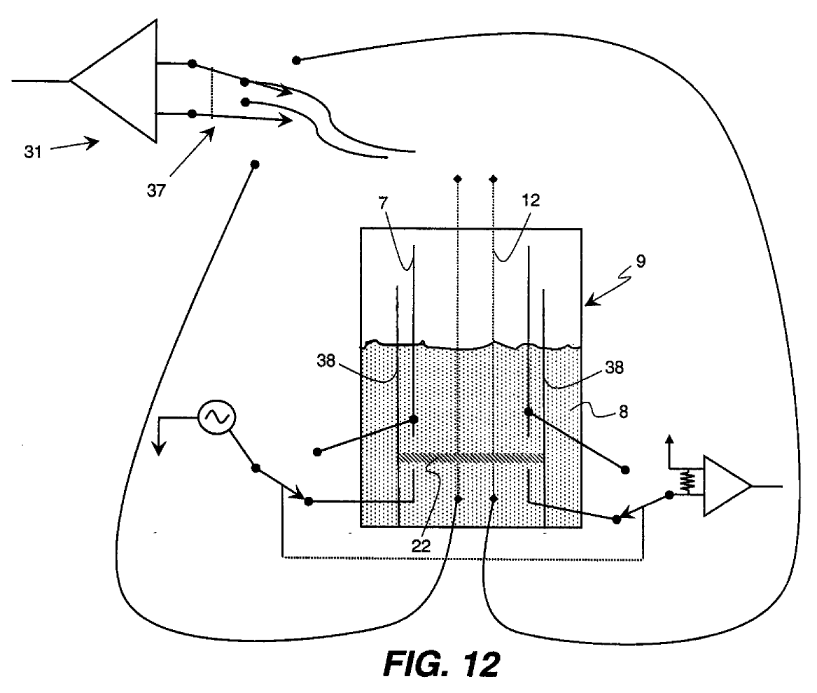

Referring to FIGS. 11 and 12, additional example embodiments of sensor 23 are shown. When the set of sense electrodes 12 is incorporated into both the first probe 32 and the second probe 33 as part of the fixed electrode configuration of each, the first and second sets of electrodes 6 and 7 should have a very specific position relative to each other. Additionally, when the set of sense probes 12 is partially submergible in the fluid 8, as shown in FIG. 3A, cross-talk between the electrodes can result, and the fluid level can influence the voltage measured by the set of sense probes 12. However, a fourth set of electrodes 35, a set of sense electrodes that is completely submergible, can be incorporated into the system, as shown in FIG. 11. Fourth set of electrodes 35 is connected to a second sense circuit 36. Alternatively, fourth set of electrodes 35 can be associated with sense circuit 31, as shown in FIG. 12. When fourth set of electrodes 35 is associated with sense circuit 31, second circuit 31 includes a switch 37 which operates to select either the third set of electrodes 12 or the fourth set of electrodes 35 for incorporation into the sense circuit. When a fourth set of electrodes 35 is included in sensor 23, second probe 33 can be positioned in a location within the tank that is physically remote from the first probe 32. As such, the second probe 33 does not affect the measurements obtained from the first probe 32, and vice versa. In this embodiment, first probe 32 includes first set of electrodes 6 and fourth set of electrodes 35. The first set of electrodes 6 is a set of driven electrodes and fourth set of electrodes 35 is a set of sense electrodes. Similarly, second probe 33 includes second set of electrodes 7 and third set of electrodes 12. Third set of electrodes 12 can be partially submergible or completely submergible. The second set of electrodes 7 is a set of driven electrodes and third set of electrodes 12 is a set of sense electrodes. Typically, first and second probes 32 and 33 each are arranged in a six-electrode configuration, as described above.

Referring to FIG. 12, other embodiments permit the inclusion of a current stop barrier 22 when separate sets of sense electrodes are used for the first and second probes 32 and 33, as described above. This current stop barrier 22 prevents the second probe 33 from interfering with the first probe 33. Current stop barrier 22 is made of an insulating material, preferably a plastic, for example, PVC, though other non-conductive materials can be used depending on the application contemplated. In this embodiment, first probe 32 includes first set of electrodes 6 and fourth set of electrodes 35, a set of sense electrodes. Fourth set of electrodes 35 detects the voltage in the fluid 8 between first set of electrodes 6. Similarly, second probe 7 includes second set of electrodes 7 and third set of electrodes 12. Third set of electrodes 12 detects the voltage in the fluid 8 between the second set of electrodes 7. Typically, first and second probe 32 and 33 are arranged in a six-electrode configuration, as described above. Electrical barrier, or current stop barrier 22, is positioned relative to the first, second, third and fourth sets of electrodes to electrically isolate the first and fourth sets of electrodes 6 and 35 from the second and third sets of electrodes 7 and 12. Current stop barrier 22 extends from wall 38 to wall 38 of the defined area where current can run through the liquid. As described previously, walls 38 can be foam barrier 17, the wall of the fluid reservoir 9, or walls constructed within the tank to define a resistive path through the fluid. This current stop barrier 22 prevents the second probe 33 from interfering with the first probe 32.

The invention has been described in detail with particular reference to certain preferred embodiments thereof, but it will be understood that variations and modifications can be effected within the scope of the invention.

### PARTS LIST

1 Drop generator
2 Deflection circuitry
3 Ink recycling unit
4 Ink reservoir
5 Heater control circuit
6 First set of electrodes
7 Second set of electrodes
8 Fluid
9 Fluid reservoir
12 Third set of electrodes
13 Set of sense electrode
16 Sealing member
17 Foam barrier
18 Small openings in the foam barrier
19 Bracket
20 Mount
21 Temperature sensing device
22 Current stopping barrier
23 Sensor
24 Electrical circuit
25 Voltage source
26 Resistor
27 Driven amplifier
28 Switch
29 Set of probes, generally
30 Sense amplifier
31 Sense circuit
32 First probe
33 Second probe
34 Processor
35 Fourth set of electrodes
36 Second sense circuit
37 Switch
38 Wall
S101 First method step
S102 Second method step
S103 Third method step
S104 Fourth method step
S105 Method decision
S106 Method decision

1. A sensor comprising:
a first set of electrodes completely submergible in a fluid;
a second set of electrodes partially submergible in the fluid; and
at least one electrical circuit operable to measure resistance of the fluid between the first set of electrodes and operable to measure resistance of the fluid between the second set of electrodes.

2. The sensor of claim 1, further comprising:
a third set of electrodes at least partially submergible in the fluid; and
a voltage sense circuit operable to measure the voltage across the fluid between at least one of the first set of electrodes and the second set of electrodes by sensing the voltage with the third set of electrodes.

3. The sensor of claim 2, wherein the electrodes of the third set of electrodes maintain a fixed geometry relative to each other.

4. The sensor of claim 2, wherein the voltage sense circuit comprises a fourth set of electrodes completely submergible in the fluid, the fourth set of electrodes being operable to measure voltage across the fluid between the first set of electrodes.

5. The sensor of claim 4, further comprising:
an electrical barrier positioned relative to the first, second, third and fourth sets of electrodes to electrically isolate the first and fourth sets of electrodes from the second and third sets of electrodes.

6. The sensor of claim 4, wherein the electrodes of the fourth set of electrodes maintain a fixed geometry relative to each other.

7. The sensor of claim 4, further comprising:
a temperature sensing device operable to sense the temperature of the fluid.

8. The sensor of claim 1, wherein the electrodes of the first set of electrodes maintain a fixed geometry relative to each other.

9. The sensor of claim 1, wherein the electrodes of the second set of electrodes maintain a fixed geometry relative to each other.

10. The sensor of claim 1, further comprising:
a temperature sensing device operable to sense the temperature of the fluid.

11. The sensor of claim 10, further comprising:
a processor configured to receive information from the electrical circuit and the temperature sensing device, and calculate a concentration of solute in the fluid.

12. The sensor of claim 1, further comprising:
an enclosure positioned about the second set of electrodes, the enclosure including a plurality of openings sized to allow the fluid to flow through the enclosure and pass around the second set of electrodes.

13. The sensor of claim 1, further comprising:
a processor configured to receive information from the electrical circuit and calculate a fluid level of the fluid.

14. A method of sensing fluid in a fluid reservoir, the method comprising:
providing a first set of electrodes completely submergible in a fluid;
providing a second set of electrodes partially submergible in the fluid;
providing at least one electrical circuit operable to measure resistance of the fluid between the first set of electrodes and operable to measure resistance of the fluid between the second set of electrodes;
measuring the resistance of the fluid between the first set of electrodes; and
measuring the resistance of the fluid between the second set of electrodes.

15. The method of claim 14, further comprising:
providing a processor configured to receive information from the electrical circuit; and
comparing the resistance of the fluid between the first set of electrodes to the resistance of the fluid between the second set of electrodes to calculate a level of the fluid in the fluid reservoir using the processor.

16. The method of claim 15, the processor including a stored fluid level value, the method further comprising:
comparing the fluid level calculated by the processor to the stored fluid level value using the processor; and
causing additional fluid to be added to the fluid reservoir when the fluid calculated by the processor is less than the stored fluid level value.

17. The method of claim 16, the processor configured to receive information from a temperature sensing device, the method further comprising:
sensing a temperature of the fluid in the fluid reservoir using the temperature sensing device;
correcting the resistance of the fluid measured between the second set of electrodes provided to the processor by the electric circuit using the temperature of the fluid provided to the processor by the temperature sensing device;
calculating a concentration of solute in the fluid using the processor.

18. The method of claim 17, the processor including a stored solute concentration value, the method further comprising:
comparing the calculated solute concentration to the stored solute concentration value; and
causing additional fluid with solute to be added to the fluid reservoir when the calculated solute concentration is less than or equal to the stored solute concentration value.

19. The method of claim 17, the processor including a stored solute concentration value, the method further comprising:
comparing the calculated solute concentration to the stored solute concentration value; and
causing additional fluid without solute to be added to the fluid reservoir when the calculated solute concentration is greater than the stored solute concentration value.
